(19) United States
(12) Patent Application Publication
(10) Pub. No.: US 2007/0031804 A1
(43) Pub. Date: Feb. 8, 2007

(54) Personalized course alerts and course completion recording service

(75) Inventors: Baiju D. Mandalia, Boca Raton, FL (US); Joseph G. Rusnak, Durham, NC (US); Robert J. Sundstrom, Cary, NC (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/198,450

(22) Filed: Aug. 5, 2005

(51) Int. Cl. G09B 3/00

(52) U.S. Cl. 434/350

(57) ABSTRACT

An automated method of providing courses to users within an organization can include subscribing a user to receive availability notifications for at least one selected course and notifying the user when a selected course is available. The method also can include detecting successful completion of the selected course by the user and responsive to the detecting step, updating a profile of the user to indicate successful completion of the selected course.

### BACKGROUND

1. Field of the Invention

The present invention relates to pervasive computing and, more particularly, to training and/or educating users of an organization.

2. Description of the Related Art

Communication technology is advancing at a rapid pace. One notable advance has been the convergence of voice and data communications. To some degree, both voice and data now can be carried over a single network. Convergence has lead to the development of unified systems which are capable of sending and receiving messages over a variety of different communication channels, referring to different forms of communication such as electronic mail, paging, facsimile, instant messaging, telephony, and the like. For example, when a sending user attempts to contact a target individual, a message from the sender can be transmitted over one or more of these communication channels.

Within such messaging systems, a communication channel often is selected according to a profile associated with the target user. For example, a profile can specify that messages sent through the messaging system to the target user should be forwarded as electronic mails on Mondays or as facsimiles on Tuesdays. One can see that the flexibility afforded by such messaging systems can significantly increase the effectiveness of communications within an organization.

To date, however, these capabilities have not been successfully integrated into the routine business processes performed within an organization. Conventional messaging systems have not been used within organizations in a proactive manner which complements or supports employee training. Accordingly, it would be beneficial to provide a system which actively supports and fosters employee training activities within a business and/or organization.

### SUMMARY OF THE INVENTION

The present invention provides a solution for facilitating the scheduling and monitoring of training within an organization and/or business. One embodiment of the present invention can include a method of providing courses to users within an organization. The method can include subscribing a user to receive availability notifications for one or more selected courses and notifying the user when a selected course is available. The method also can include detecting successful completion of the selected course by the user and responsive to the detecting step, updating a profile of the user to indicate successful completion of the selected course.

Another embodiment of the present invention can include a method of providing courses to users within an organization. The method can include registering a user to receive notifications of course availability in accordance with a course profile specifying a plurality of courses to be completed. The user can be notified of availability of different ones of the plurality of courses specified by the course profile. A determination can be made when individual ones of the plurality of courses are successfully completed by the user. The method also can include updating a profile associated with the user based upon said determining step.

Yet another embodiment of the present invention can include a machine readable storage being programmed to cause a machine to perform the various steps described herein.

### BRIEF DESCRIPTION OF THE DRAWINGS

There are shown in the drawings, embodiments which are presently preferred; it being understood, however, that the invention is not limited to the precise arrangements and instrumentalities shown.

FIG. 1 is a block diagram illustrating a training notification and recording system in accordance with one embodiment of the present invention.

FIG. 2 is a flow chart illustrating a method of scheduling courses and monitoring course completion within an organization in accordance with another embodiment of the present invention.

### DETAILED DESCRIPTION OF THE INVENTION

The present invention provides a method and apparatus for providing course alerts, or notifications, and monitoring course completion for users. The inventive arrangements disclosed herein allow an institution to set a discipline, or course profile, for the training and assignment of its employees to maximize efficiencies and facilitate skill availability for optimal operations. Rule based context information programming facilitates adaptation of training to individual training needs and business goals.

In accordance with the inventive arrangements disclosed herein, users can be registered, on an individual basis, to receive notifications regarding training schedules, course availability, and/or post training tasks. While users can register for such courses manually, in another aspect, users can be automatically registered for courses. The users can be registered for the courses based upon the availability of each user and the dates and times at which each course can be taken or is otherwise available.

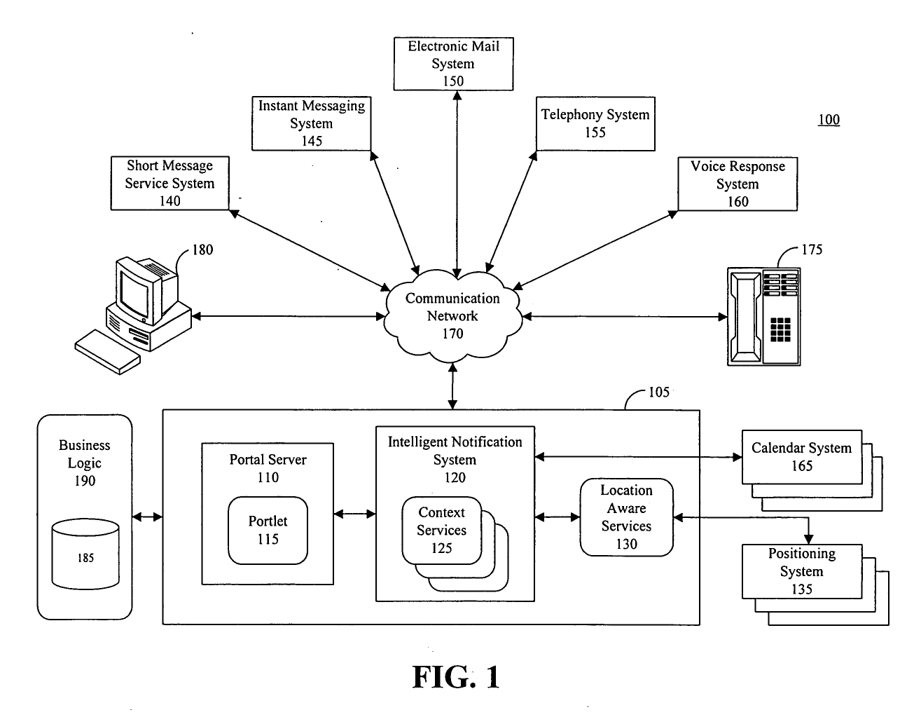

FIG. 1 is a block diagram illustrating a training notification and recording system 100 in accordance with one embodiment of the present invention. The system 100 can include an on-demand computing environment (computing environment) 105 for providing applications to mobile users. Computing environment 105 can be configured as a middleware platform that provides an integrated client-server environment and application development tools to extend business applications and data to mobile devices. Computing environment 105 provides the back-end integration framework necessary for providing functions including, but not limited to, mobile personal information management, electronic mail synchronization, and access to World Wide Web (Web) based and other content.

In one embodiment, computing environment 105 can be implemented as WebSphere® Everyplace Access, which is commercially available from International Business Machines Corporation of Armonk, N.Y. (IBM). WebSphere® Everyplace Access is described in greater detail in the following publications, which are incorporated herein by reference: IBM WebSphere Everyplace Access V5 Handbook for Developers and Administrators, Volume IV: Advanced Topics, IBM (March 2005); IBM WebSphere Everyplace Access V5 Handbook for Developers and Administrators, Volume II: Application Development, IBM (March 2005); and Adding Voice to your Portlet Applications, IBM (July 2004). In any case, the use of a particular computing environment 105 is not intended to limit the scope of the present invention.

The computing environment 105 can include a portal server 110, an intelligent notification system (INS) 120, and location aware services 130. The portal server 110 provides a simple, unified access point through which a variety of functions can be accessed. Although the term “portal” can be used in reference to Web-based applications, this need not be the case. The portal server 110 can be implemented as an application that provides content and/or functionality aggregation regardless of whether the Web or markup language(s) are used. For example, in one embodiment, the portal server 110 can be implemented as WebSphere® Portal, which is available from IBM.

The portal server 110 can include one or more portlets 115. Each portlet 115 can serve as a reusable software component which can execute within the portal server 110. Each portlet 115 can be considered a complete application which can follow a standard model-view-controller design. Further, each portlet 115 can have multiple states and view modes, as well as event and messaging capabilities.

In illustration, one portlet 115 can provide a function such as document searching, another can provide user login and/or security, and another can serve as an electronic mail client. With respect to the present invention, a portlet 115 can be provided which allows a supervisor of an organization to run a daily report regarding the status of training for one or more users, or employees. The portlet 115 can be accessed visually or by voice. The portlet 115 can be programmed to obtain context information from the INS 120 and provide employee availability information based upon that context information. The portlet 115 further can trigger one or more notifications or actions, such as scheduling an employee needing training for a particular training class that is available. It also should be appreciated that the portlet 115 can be configured to automatically execute from time to time or periodically as the case may be.

In general, the INS 120 collects context information from any of a plurality of different sources. This allows enterprises to send messages to mobile users to improve information flow and business efficiency. Context services 125 are disposed within the INS 120. The context services 125 can acquire and analyze context information relating to the availability of users and make this information available to the INS 120 and other components of system 100 that may have a need to use such information.

As used herein, context information can include, but is not limited to, information relating to one or more individuals as may be acquired from any combination of location aware services 130, a calendar system 165, positioning systems 135, and presence-providing systems such as instant messaging (IM) system 145 and/or a telephony system 155, which can be implemented as an Internet Protocol (IP) telephony system. Context information also can be provided from Short Message Service (SMS) system 140, which can be implemented as a Wireless Application Protocol (WAP) based system, and electronic mail system 150. With respect to the messaging systems 140-155, for example, the context services 125 can be configured to communicate with presence servers through appropriate communication protocols such as SIP for Instant Messaging and Presence Leveraging Extensions (SIMPLE) for communication with an IM system 145 presence server, Parlay for communicating with a telephony system 155 presence server, and the like.

It should be appreciated that the listing of systems from which context information can be derived is not intended to be exhaustive. As such, the list serves only as an example of some of the different types of systems that can be used in conjunction with the INS 120 and from which context information can be obtained for purposes of determining availability of an individual. For example, other means of determining context information can include, but are not limited to, providing a network-connected application that users can use to manually toggle availability from available to not available similar to IM system 145. Workstation agents can be used which detect activity on the workstation and the type of activity that is taking place on the workstation such as the particular application being used, whether a Web conference is ongoing, and the like. Motion and/or sound detectors also can provide context information. Other examples of context information and applications thereof can be found within J. Fogarty and S. Hudson, Examining the Robustness of Sensor-Based Statistical Models of Human Interruptibility, CHI 2004, Apr. 24-29, 2004, Vienna, Austria, which is incorporated herein by reference.

In any case, the INS 120 can interact with different messaging systems such as SMS system 140, IM system 145, electronic mail system 150, telephony system 155, and voice response system 160. The INS 120 can instruct the various messaging systems to send messages, interpret user response data received from the messaging systems, as well as implement the communications capabilities between these systems and the location aware services 130.

For example, a context service 125 can be provided which polls the IM system 145 to determine whether a particular user is logged onto the IM system 145. The context service 125 further can be tasked with communicating with the IM system 145 to command the IM system 145 to send a communication, i.e. an instant message, as well as interpret data received from the IM system 145 such as user responses. In another example, a context service 125 can be provided which can query the calendar system 165. The context service 125 can be configured to interact with the calendar system 165 to obtain scheduling information for selected user(s).

In yet another example, the INS 120 can interact with the voice response system 160 and instruct it to perform various functions. Voice response system 160 can perform functions such as placing telephone calls via telephone system 155 and conducting dialogs with a call recipient. Accordingly, the voice response system 160 can provide functions including, but not limited to, executing applications such as Voice Extensible Markup Language (VoiceXML) applications, playing recorded prompts, prompting users through text-to-speech technology, speech recognizing user spoken utterances, and recognizing dual tone multi-frequency (DTMF) input. These capabilities can be used to supply interactive voice response functions for telephone calls conducted over telephony system 155.

In one embodiment, the voice response system 160 can be implemented as, or include, WebSphere® Voice Response, WebSphere® Voice Application Access, and WebSphere® Voice Server, each being available from IBM. WebSphere® Voice response provides telephony connectivity to WebSphere® voice applications, which can be executed therein. WebSphere® Voice Server provides text-to-speech functionality and automatic speech recognition functions. WebSphere® Voice Application Access provides rendering of voice to WebSphere® Portal applications such as portlets 115.

Users can subscribe to services set up by a system administrator, and receive timely, personalized alerts through the INS 120. The INS 120 allows users to be subscribed to events and to specify an action to be taken when a match is found between a subscription and an event that is passed to the INS 120. For example, the communication capabilities of the INS 120 can be used to notify a user of the occurrence of an event.

Thus, the INS 120 and/or the context services 125 can be configured to perform a variety of different functions relating to context information. Other examples of functions which can be performed by the INS 120 can include collecting, maintaining, and disseminating context information as disclosed in U.S. Patent Publication No. 2003/0018692 entitled “Method and Apparatus for Providing a Flexible and Scalable Context Service”; providing context-aware unified communication for enabling communications between users over a common communications platform or heterogeneous communication platforms as disclosed in U.S. Patent Publication No. 2004/0203664 entitled “System and Method for Context-Aware Unified Communications”; as well as fuse context data for use by context aware applications as disclosed by U.S. Patent Publication No. 2004/0111397 entitled “Method and Apparatus for Fusing Context Data”. Each of these patent publications is incorporated herein by reference.

Location aware services 130 provide a framework for integrating real time location information into communications and business applications. In one embodiment, the location aware services 130 provide the functionality and/or interfaces necessary for interacting with various positioning systems 135. Each location aware service 130 can be tasked with communicating with a particular positioning system 135. The positioning systems 135 can include, but are not limited to, short range wireless location tracking systems such as those based upon one of the 802.11 wireless communication protocols, Global Positioning Systems, and the like. In any case, the location aware services 130 can communicate with the various positioning systems 135 to determine whether a particular user, or more particularly mobile user device, is locatable, and if so, the location for that device and corresponding user.

Location aware services 130 also can be organized at a higher level. For example, the location aware services 130 can include services such as geocoding in reference to determining geographical coordinates for an address received as input, reverse geocoding, directory services where points of interest are located proximate to a given location, routing in reference to determining physical directions from one location to another, mapping which provides a map of a designated location, and device positioning which returns a location of a user's device.

Business logic 190 can be implemented as a collection of one or more software applications which implement various business processes and/or functions. Data required by the business logic 190 can be stored within data store 185, for example within a database or other suitable data structure. It should be appreciated, however, that data also can be obtained from, or maintained by, an outside data source. In any case, the various capabilities described herein with respect to presence detection, messaging, and calendaring can be accessed by the business logic 190 via the INS 120 and/or portal server 110.

Communication network 170 can include the Internet, the Web, Local Area Networks, Wide Area Networks, the Public Switched Telephone Network, wireless networks whether mobile and/or cellular networks as well as shorter-range wireless networks such as 802.11 type networks, Bluetooth type networks, and the like. In any case, the particular network architecture used is not intended as a limitation of the present invention.

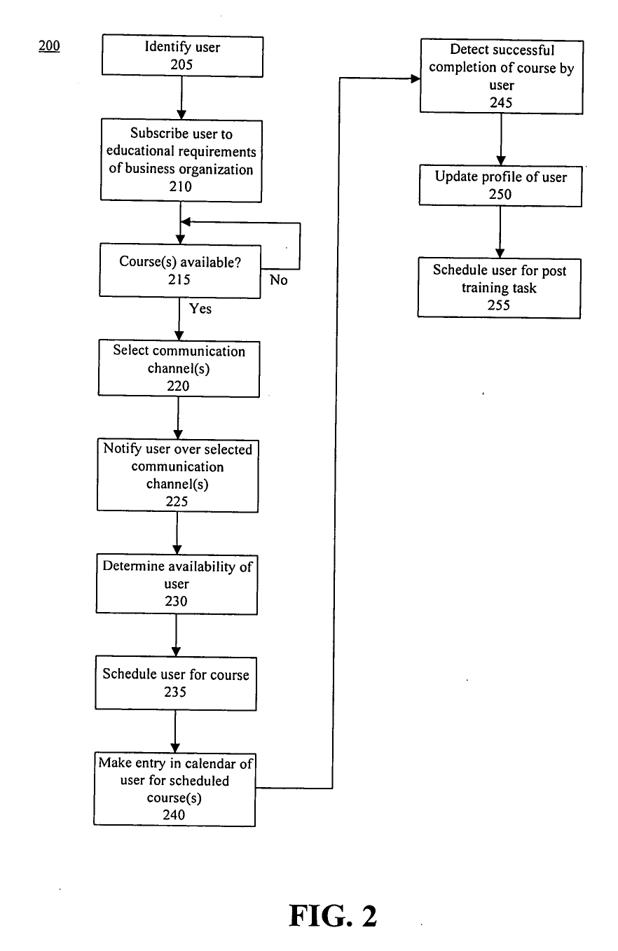

FIG. 2 is a flow chart illustrating a method 200 of scheduling courses and monitoring course completion within an organization in accordance with another embodiment of the present invention. In one aspect, method 200 can be implemented using the system illustrated with reference to FIG. 1. The method 200 can begin in a state where one or more employees or users within a given organization have a need for training and/or other educational services.

In one embodiment, the courses can be provided as conventional “in-person” classroom style courses. In another embodiment, the courses can be delivered through a communications network such as the Internet, the Web, or another sort of network or intranet. The particular way in which the courses are implemented and/or delivered is not intended as a limitation of the present invention. In this regard, the courses can be self-paced, interactive, include streaming audio and/or video, whether live or recorded, have a real time communication component for example through IM, or include any combination of these attributes.

Method can begin in step 205 where a user can be identified. The user can be an employee of the organization that may require training of one sort or another. For example, the user can be a new hire who is to take one or more courses. In another example, the user can be an existing employee that is to undergo training in a particular area. Such training can occur or be mandated from time to time, on a periodic basis, or as new and/or updated courses become available. A course can be said to be available when users can be registered for the course and/or when a notification regarding course availability, or that the course is available, is posted to the INS.

In step 210, the user can be subscribed to particular educational requirements of the business organization. In one embodiment, a system administrator, working through a portlet, can manually subscribe the user with the INS to receive notifications for the availability of particular courses. The courses to which the user is subscribed can be specified within a course profile. The course profile can specify various courses that the user is to take, for example, as may be required in the performance of the user's job or as specified in a job description for the user within the organization. Accordingly, the course profile can specify one or more courses which the user is expected to complete to perform his or her job.

In another embodiment, the course profile can specify courses which correspond to a particular business goal of the organization. In yet another embodiment, the courses specified by the course profile can be those which the user has decided may enhance his or her abilities or achieve a particular individual goal. That is, the user can define the courses include within his or her course profile. In any case, each course profile can be tailored, or specific, to a given individual.

In another embodiment, the user can be associated with a course profile stored within the data store of the business logic. The business logic automatically can subscribe the user to receive notifications for course availability through the INS. The particular notifications for course availability to which the user is subscribed can correspond to those courses enumerated in the course profile associated with the user.

In step 215, a determination can be made as to whether a course has become available. The INS can continually monitor for events being posted thereto, in this case, events relating to course availability which are posted by the business logic. Accordingly, the INS can determine whether an event indicating that a course is available has been received. The INS farther can determine whether any such events correspond to the particular events which represent the availability of particular courses for which the user has subscribed. If so, the method can proceed to step 220. If not, the method can continue to monitor for the occurrence of such an event.

In step 220, a particular communication channel can be selected over which the user can be notified of the occurrence of the event. The communication channel can be selected according to the availability of the user. Availability can be determined according to context information collected for the user. As noted, context information can include calendar information, presence information, location information, as well as other sensor information, which when taken collectively, can indicate the availability of the user as well as which communication channel is most likely to be able to reach the user.

In one embodiment, a portlet can be implemented which institutes a policy for interpreting context information. The portlet can resolve conflicting instances of context information and indicate a particular communication channel to be used in view of the available context information for the user. In one embodiment, the policy implemented by the portlet can prioritize and/or assign weights to the different types of context information such as calendar, presence, location, or subsets thereof such as IM presence, telephony presence, and the like. For example, presence information can be considered more important than location or calendar information when determining availability. In another example, calendar information can be given the highest priority. This allows administrators to establish policies defining a hierarchy of context information importance which can be used to determine user availability and/or measures of availability as the case may be.

The policies for interpreting context information can vary in complexity in order to resolve ambiguities in the context information. For example, a policy can indicate that if a conflict arises between calendar information and presence information, then presence information is used in lieu of calendar information. Thus, if the calendar system indicates that the user is free, but the user does not have a presence on any messaging system, a determination can be made that the user is not available. Similarly, if the calendar system indicates that the user is free, but the user is off-site and does not have a presence on a messaging system, a determination can be made that the user is not available.

In any case, the portlet can select a particular communication channel over which the notification can be sent. In step 225, the INS, under the direction of the portlet, can send a notification over the selected communication channel. It should be appreciated that the notification can be sent over a plurality of different communication channels if the policy provides for such action. Thus, the INS can send an electronic mail notification, a voice mail through the voice response system, an IM, a text message, etc. The notification can indicate that a needed course for the user is available or has been announced.

If the course is available online, the notification can indicate such information. If the course is a conventional “in-person” classroom style course, or the course is to be delivered in another format on a particular date and at a particular time, the notification can indicate the date and time of the course. While the user can register for the course responsive to the notification in a manual fashion, in another embodiment, the user can be registered for the course automatically. Similarly, if the course is a prerecorded course that is available online, the user can manually select a time that is convenient to take the course. The user, however, also can be automatically scheduled for the course based upon the user's availability.

Accordingly, in step 230, the availability of the user can be determined. A portlet can query the INS for context information and determine a date and/or time when the user is available based upon the obtained context information. If the course for which the notification has been sent has an associated date and time, the INS can determine the availability of the user for that date and time, for example using calendar information for the user. If the course is not associated with a particular date and time, for example in the case of a recorded Webcast, the INS can determine availability of the user during a future time period, i.e. over the next day, week, month, several months, or the like.

In step 235, the INS can schedule the user for the course. In the case of a course with a particular date and time, if the user is available, the INS can schedule the user for the course. That is, the portlet can register the user with the business logic for participation in the course. If the course is not associated with a particular date and/or time, the portlet can select a date and time when the user is available and schedule the user to take the course on the selected date at or about the selected time.

In step 240, the portlet can communicate with the calendar system via the INS to place an entry corresponding to the course in the calendar of the user. The entry can indicate the date and time for which the user has been registered to participate in the course. In step 245, a determination can be made as to whether the user successfully completed the course. When a user completes a course, an administrator can be tasked with updating the business logic or other data store with that information. In another embodiment, for example in the case of an online course, the business logic or data store can be updated automatically to indicate that the user has successfully completed the course.

In any case, a portlet can be configured to access the business logic, or a data store contained therein, to determine when and if the user has successfully completed one or more courses. The portlet can be run automatically from time to time, on a periodic basis, or manually started, for example by an administrator running a training report. Accordingly, in step 250, responsive to determining that the user has successfully completed one or more courses, the portlet can update the profile for the user maintained within the business logic.

Subsequently, in step 255, the user can be scheduled for a post training task. More particularly, the user can be scheduled, automatically, to perform a given task within the organization. The task can be one for which the user has been trained, or is qualified, as indicated by completed training courses specified by the profile for the user. That is, the task can require successful completion of a particular training course as a prerequisite.

For example, in one embodiment, the user can be associated with a customer based upon the user's updated profile and one or more customer attributes as may be specified in a customer profile or as entered by customer service personnel. By automatically updating the user, or employee, profile to indicate those courses that have been successfully completed by the employee, customers can be matched to qualified employees, i.e. those that have been trained in a particular area or that have specialized expertise that may be needed by the customer, in a more effective manner.

It should be appreciated that while method 200 has been described largely with reference to a single course, that the present invention also can schedule and register a user with multiple courses. Further, one or more steps can be performed in varying order without departing from the spirit of the invention. One or more steps also can be optional in nature. In illustration, notification(s) of course availability need not be sent in all cases. Users can be automatically registered for one or more courses and calendar entries can be placed into the user's calendar to indicate that the user has been registered for the course(s).

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program, software application, and/or other variants of these terms, in the present context, mean any expression, in any language, code, or notation, of a set of instructions intended to cause a system having an information processing capability to perform a particular function either directly or after either or both of the following: a) conversion to another language, code, or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. An automated method of providing courses to users within an organization comprising:
subscribing a user to receive an availability notification for at least one selected course;
notifying the user when a selected course is available;
detecting a successful completion of the selected course by the user; and
responsive to said detecting step, updating a profile of the user to indicate successful completion of the selected course.

2. The method of claim 1, further comprising selecting the user from a plurality of different users to be associated with a customer based upon a correspondence of courses completed by the user as indicated by the updated profile of the user and at least one attribute of the customer, whereby the correspondence indicates that the user has received training for a customer need indicated by the at least one attribute of the customer.

3. The method of claim 1, further comprising automatically registering the user for the selected course.

4. The method of claim 3, wherein the user is automatically registered for the selected course based upon availability of the user on a date and at a time when the selected course is scheduled.

5. The method of claim 1, further comprising placing an entry corresponding to the selected course in an electronic calendar associated with the user.

6. The method of claim 1, said method further comprising:
determining availability of the user based upon context information;
selecting a date and a time when the selected course is to be given according to the availability of the user; and
playing the selected course through a workstation associated with the user on the date and at about the time.

7. The method of claim 1, said notifying step further comprising selecting at least one communication channel, according to context information for the user, over which a notification is sent.

8. An automated method of providing courses to users within an organization comprising:
registering a user to receive notifications of course availability in accordance with a course profile specifying a plurality of courses to be completed;
notifying the user of availability of different ones of the plurality of courses specified by the course profile;
determining when individual ones of the plurality of courses are completed successfully by the user; and
updating a profile associated with the user based upon said determining step.

9. The method of claim 8, further comprising selecting a communication channel from a plurality of communication channels, according to context information for the user, for notifying the user.

10. The method of claim 8, further comprising automatically scheduling the user for at least one of the plurality of courses specified by the course profile.

11. The method of claim 10, further comprising automatically playing the at least one of the plurality of courses through a workstation associated with the user on a scheduled date and at about a scheduled time.

12. The method of claim 10, further comprising automatically placing an entry corresponding to at least one of the plurality of courses for which the user has been scheduled in an electronic calendar corresponding to the user.

13. The method of claim 8, further comprising:
determining availability of the user according to context information; and
registering the user for at least one of the plurality of courses based upon the availability of the user.

14. The method of claim 12, further comprising selecting a date and a time for the at least one of the plurality of courses according to the availability of the user.

15. The method of claim 8, further comprising:
determining that the user is qualified to perform a selected task according to courses that have been completed successfully as specified in the profile; and
scheduling the user to perform the task.

16. The method of claim 8, wherein the plurality of courses specified by the course profile corresponds to a task to be performed by the user.

17. The method of claim 8, wherein the plurality of courses specified by the course profile is defined by the user and corresponds with a training goal of the user.

18. The method of claim 8, wherein the plurality of courses specified by the course profile corresponds to at least one business goal of the organization.

19. A machine readable storage, having stored thereon a computer program having a plurality of code sections executable by a machine for causing the machine to perform the steps of:
registering a user to receive notifications of course availability in accordance with a course profile specifying a plurality of courses to be completed;
notifying the user of availability of different ones of the plurality of courses specified by the course profile;
determining when individual ones of the plurality of courses are completed successfully by the user; and
updating a profile associated with the user based upon said determining step.

20. The method of claim 8, further comprising selecting a communication channel from a plurality of communication channels, according to context information for the user, for notifying the user.
